(19) United States
(12) Patent Application Publication
(10) Pub. No.: US 2023/0173418 A1
(43) Pub. Date: Jun. 8, 2023

(54) Nanofilter System for Personal and Medical Protective Equipment with Nano-Facemask, Resp. Nano-Faceshield and Method of Manufacturing Thereof

(71) Applicants: Stergios Logothetidis, Thessaloniki (GR); Varvara Karagkiozaki, Thessaloniki (GR); BL NANOBIOMED PRIVATE COMPANY, Thermi Thessaloniki (GR); ARISTOTLE UNIVERSITY OF THESSALONIKI E.L.K.E., Panepistimioupoli Thessalonikis (GR)

(72) Inventors: Stergios Logothetidis, Thessaloniki (GR); Varvara Karagkiozaki, Thessaloniki (GR); Alexandros Orfanos, Thessaloniki (GR)

(73) Assignees: Stergios Logothetidis, Thessaloniki (GR); Varvara Karagkiozaki, Thessaloniki (GR); BL NANOBIOMED PRIVATE COMPANY, Thessaloniki (GR); ARISTOTLE UNIVERSITY OF THESSALONIKI E.L.K.E., Panepistimioupoli Thessalonikis (GR)

(21) Appl. No.: 17/996,967

(22) PCT Filed: Apr. 26, 2021
(86) PCT No.: PCT/GR2021/000023

§ 371 Date: Oct. 24, 2022

(30) Foreign Application Priority Data
Apr. 24, 2020 (GR) 20200100210

(51) Int. Cl. B01D 39/16; A41D 13/11

(52) U.S. Cl. CPC B01D 39/1692; A41D 13/1192; B01D 39/1623; B01D 2239/0258; B01D 2239/0266; B01D 2239/0428; B01D 2239/0442; B01D 2239/0478; B01D 2239/0631; B01D 2239/065; B01D 2239/10; B01D 2239/1208; B01D 2239/1216

(57) ABSTRACT

The present invention relates to nanofilters and nanofliter systems for personal and health care protective equipment to protect against health and safety hazards having application in healthcare, industrial, public, domestic environments, They are applied to face masks, respirators, face shields, protective glasses and clothes, to protect healthcare workers and other individuals against microparticles, dust, bacteria, fumes, vapors, gases, allergens, air pollutants, airborne microorganisms and especially nanosized viruses such as influenza, HIV, SARs, SARs-CoV-2. It also relates to a method for fabricating thereof with higher filtration efficiency, and to Nano-face masks, respirators, Nano-face shields exhibiting antibacterial, anti-viral protection and particulate-filtering due to the excellent barrier and filtration properties of the nanofliter system. It is also applied to the delivery of nanoparticles, organic or inorganic with antibacterial, antiviral properties, drugs, therapeutic agents, nanomedicines, or/and compounds, sensors,

### TECHNICAL FIELD

The present invention relates to the design and production of nanofilters and nanofilter systems with high efficiency filtration even at nanoscale for personal and health care protective equipment to protect against health and safety hazards.

### TECHNOLOGICAL BACKGROUND

The outbreak of multiple severe incidents related to acute respiratory syndrome (SARS) in the early 2000s led to an imperative use of various respiratory devices towards the protection of healthcare workers primarily, and secondary to all the civilians [1,2]. The 2009 H1 N1 influenza pandemic was a significant spur to research in the field of influenza transmission and infection prevention. Respiratory devices are used to protect against potentially hazardous biological aerosols that can transmit—via inhalation—microparticles, and therefore microorganisms like viruses or bacteria [2].The route of pathogens' transmission alters according to their characteristics and it generally involves the blood borne, droplet, airborne and contact (direct and indirect) transmission [3].ln particular, viruses of the family of Coronaviridae, including the recently identified SARS-Cov-2 virus causing the COVID-19 pandemic worldwide [4,5] and the majority of influenza-type viruses bear a rather small size of approximately 60-150 nm [6,7]. This fact renders the airborne transmission of those viruses highly invasive and as such advanced personal protective equipment with filter materials at the nanoscale is thus imperatively required.

The National Institute for Occupational Safety and Health (NIOSH) provides a listing of all the available NIOSH-approved disposable or filtering face piece respirators (FFRs, e.g. N95, N99, N100, P95, P99, P100, R95, R99, and R100) used against the spread of influenza-like infections [1,8]. The common principle for all protective respiratory equipment lies on the basis that modified filters must capture the full range of hazardous particles within a size spectrum (<1 to >100 μm) and over a range of airflow (approximately 10 to 100 L/min), with as much as possible minimum leakage of the pathogens. Most specifically, in the case of respiratory virus infections which are characterized by high transmission rates and invasiveness, both plain surgical masks and the most advanced filtering face piece respirators have been utilized massively in the healthcare institutions and of course in public for the protection of individuals [2,9].

Specifically, FDA-approved surgical masks (regulated under 21 CFR 878.4040) are composed of a loose-fitting, disposable non-woven fabric that covers the mouth and nose of the wearer and therefore creates a physical barrier preventing the inhalation of the pathogens. Surgical masks, designated hereafter as (SM), block the large particles in general, such as droplets, splashes, sprays, or splatter in 0,04-1,3 μm size range or above, and this efficiency can be regulated according to their thickness characteristics. Apparently, they do not tightly seal the face skin, and as such SMs couldn't be recommended for use in the case of highly airborne infectious diseases where the biological particles can enter/slip the wearer's breathing zone [1-2, 8].Therefore, SMs have been relegated for protection against infection through fluid repellence only [8].

The alternative advanced device of SMs is the N95 FFRs. The protection magnitude that they offer is 8-12 times higher than the SMs8. A N95 FFR is a tight-fitting, class Il respirator that can ideally filter out at least 95% of very small particles (0,3-0,5 μm) including oil-based particles, bacteria and viruses, when air is breathed though it [2,10]. Their shape includes half-face, with mouth and nose both covered, and full-face wherein eyes are covered in addition to mouth and nose: these types vary in their nominal ability to resist penetration by aerosols [3]. Respirator filters must undergo strict certification tests (42 CFR Part 84) established by NIOSH10. Bacterial filtration efficiency, designated hereafter as BFE is a measure of the effectiveness of a material to filter bacteria 3,0 μm in size, whereas filtration efficiency, designated hereafter as FE, is a measure of the effectiveness of a material to filter submicron (median diameter of 0,075 μm) particles of NaCl. Medical masks have a BFE of >95-99% and an FE of >78-87%. The N95 respirator has an FE of >95% and a BFE of >99% [10].

The N95 respirators are mainly manufactured for use in industrial type profession where workers are exposed to dust and small airborne particles. In a respiratory virus infection pandemic outbreak, N95 FFRs are intended for use by the healthcare personnel who are in direct need of protection against the virus containing micro particles [11]. It is to be noted that N95 FFRs are also disposable in use as the SMs.

It has been reported that both SMs and N95 FRRs bear an equivalent protective effect at low viral concentrations incidents [12]. Their ultimate effectiveness, though, comes from the consistent and correct usage. In a recent study by V. Offeddu et al., the research group evaluated the effectiveness of masks and respirators against respiratory infections in healthcare workers. The findings suggested that N95 FFRs exhibited superior protective activity against clinical respiratory illness and laboratory-confirmed bacterial infections, but not for viral infections [13]. Loeb et al. investigated back in 2009 the rates of influenza infection in nurses in Ontario, Canada, who were randomized to wear either N95 respirators or surgical masks when providing care to patients with febrile respiratory illnesses. The results showed no significant difference in influenza infection rates between the two groups; both were close to 23% [14]. MacIntyre and co-workers supported back in 2011 that N95 respirators showed mediocre protection against viral infection in nurses in Beijing, China, similarly to the respective surgical masks used [15]. A few years later, the same group investigated again the N95 respirators compared to surgical masks, showing that they provided much better protection for healthcare workers against bacterial infections in the respiratory tract, but no significant superiority against viral-based incidents [16].

The existing technology for the fabrication of facemasks, respirators and other protective medical and personal equipment enables the production of microporous filter materials woven and non-woven fabrics. Hence, such microporosity hinders the ability to block nanometer sized particles, viruses like Influenza, SARs-Cov-2, respiratory syncytial virus (RSV), human parainfluenza 3 (HPIV-3) and other, chemicals, gases leading to inadequate protection of the user.

This technical drawback renders imperative the need for the contribution of Nanotechnology which is an emerging field of applied science and cutting edge technology that produces nanomaterials and utilizes their physico-chemical properties as a means to control their size, surface area, and shape [17].

### PRIOR ART

Document EP2703016A1 discloses a method for production of nanoporous multi-layer biodegradable polymeric coatings and products thereof. Said document neither addresses nor discloses nanofilters, functionalized nanofilters, nanofilter systems, Nano-face masks and shields however.

### AIM OF THE INVENTION

This is a lack that the invention aims at remedying to. A purpose of the invention is the design and fabrication of Nano-face masks, respirators, Nano-face shields exhibiting antibacterial, anti-viral protection and particulate-filtering due to the high efficiency of the nanofilter system. Hence, these nanotechnology-enabled products may have application in healthcare, industrial, public, domestic, or other environment and can be used as protective equipment for healthcare workers, any workers subject to harsh environmental conditions, or individuals during a pandemic like COVID-19, influenza and other.

This invention lies on the design and production of tailored Nanofilters with high efficiency filtration and protection for personal protective equipment to overcome the said shortcomings in the prior art and to produce nanofilter systems. These nanofilters and Nanofilter Systems is may be applied to Nano-face masks, respirators, face'shields, protective glasses and clothes, without being limited there, to protect healthcare workers and other individuals against micro particles, dust, bacteria, fumes, vapors, gases, allergens, air pollutants, airborne microorganisms and especially nano sized viruses, such as influenza, HIV, SARs, SARs-CoV-2, etc.

The nanofilters may be also applied to the delivery of nanoparticles, organic or inorganic ones with antibacterial and antiviral properties, drugs, therapeutic agents, (bio) sensors, diagnostic, theranostics, nanomedicines, or/and compounds, without being limited thereto.

The high efficiency of air filtration and ease of breathing, as well as personal protection is achieved by the structure, nanostructures, and by the tailoring of the nanoporosity, morphology, and thicknesses of the nanolayers and filters in parallel with the design of robust, reusable Nano-face masks, and the presence of exhalation valve. Another paradigm of nanofilter to advance the protective equipment is its deposition onto Nano-face shield either alone or with functional nanoparticles with enhanced antibacterial, anti-viral properties.

### SUMMARY OF THE INVENTION

To achieve the objectives above, the following technical solutions are proposed according to the present invention. A Nanofilter System used in Nano-face masks, respirators and other of the present invention consists of:
an external, coarse filter thick layer with microporosity for filtration of microparticles;
an intermediate Nanofilter onto a functional, thick, microporous, fiber-based filter layer. The nanofilter consists of multi-functional, nanoporous nanolayers, involving single or more discrete layers, with or without nanoparticulate layer;
an inner filter of thick layer with microporosity and comfortable use.

The intermediate multi-functional layer blocks viruses, allergens, bacteria, mold, nanosized particles, chemicals but allows breathability through the whole surface area.

The external filter layer is disposed on the middle layer and is composed of non-woven fiber material that is microporous and breathable, like polypropylene (PP), polystyrene, polycarbonate, polyethylene, and combinations thereof or polyesters, other hydrophobic polymers, hydrophobic fluoropolymers, or polymers with hydrophobic surfactants, fluoro-surfactants, and others.

The tailored multi-functional, multilayer can serve as the middle layer disposed on the inner layer made of nonwoven fiber material suitable to contact the wearer's face and for comfortable use.

The Intermediate Nanofilter is composed of: a) Nanoporous nanolayers that consists of single layer biodegradable polymeric, designated hereafter as BP blends or of multi-layer BP thin films—with multi-sized nanopores and nanometer thickness—, characterized by tailored nanopores, controllable thickness of the layers to entrap nanoscale viruses, and to allow good breathing, b) Layer of Nanoparticles or other functional agents, for nanolayer biofunctionalization. The nanofilter may be biofunctionalized or not with the Nanoparticulate layer and it is deposited onto a Functional, thick, microporous, fiber-based filter layer.

The nanoporous layers of the filter may be constituted by a diversity of biodegradable polymers to different types of Poly (DL-lactide-co-glycolide) (PLGA) in terms of lactide: glycolide ratio, polycaprolactone (PCL), Polylactic acid (PLA), polysaccharides, polyesters, natural polymers with variations in degradation rates without being limited thereto. In addition, other BPs, though not limited, to BP aliphatic polyesters can be used as well such as homopolymers and copolymers of lactic acid, glycolic acid, trimethylene carbonate, and blends. The functional, thick, microporous filter layer is preferably fiber-based and made of non-woven fabrics, Polyamide (PA) and others.

In terms of the biofunctionalization process of the intermediate layer, and in order to enhance the anti-bacterial and anti-viral activities of the filter system, a diversity of nanoparticles, designated hereafter as NPs, can be loaded in the filter layers and mostly in the nanoporous layers like inorganic ones silver, titanium nitride, zinc oxide, gold, etc., and organic, polymeric NPs, loaded with anti-bacterial, anti-virus and other therapeutic agents, Silver/Metal compounds, quaternary ammonium compounds, N-halamines and anti-septic agents, without being limited thereto.

The monomers ratio, molecular weight, crystallinity, hydrophilicity and surface free energy of to the BPs, the BPs deposition in a specific order, the polymer: blend ratio, the polymer: NPs ratio in the thin films, combined with their desirable concentration, therapeutic actions are the main parameters to consider for optimization of the process.

Wetting and printing techniques, including gravure and ink jet printing, slot-die coating, dipping, spin coating, spray coating, electro spraying can be applied for the fabrication of the nanoporous BP layers onto organic and inorganic substrates and their functionalization, without being limited thereto.

The design of the nanofilter systems and the selection of materials, polymers, plastics, woven and non-woven ones and nanomedicines, drugs, nanoparticles and compounds should be made in line with the specific application. The dimensions, shape, density, interconnectivity of the nanopores, the thickness of the layers determine the filtration efficacy.

The control of nanoporosity and thickness of the engineered nanomaterials can be achieved upon the fabrication method, such as alterations in deposition parameters, polymer types, material and ratios, in line with ultrasensitive measurements and monitoring by Atomic Force Microscopy and Spectroscopic Ellipsometry referred to hereafter as AFM and SE resp. The detailed characterization of the structural properties of the engineered systems is essential for the achievement of their functionality.

This invention further relates to the fabrication of a Nano-facemask comprising the nanofilter system with or without exhalation valve, breathing chamber and of a Nano-faceshield for antibacterial and anti-viral protection by applying the Nanofilters, after the appropriate design and development of the said components.

In the case of protective face shields and eye glasses, the transparency of the nanofilter deposited onto the substrate like polyethylene terephthalate (PET), polycarbonate, cellulose acetate, is essential for the vision of the wearer in line with the good impact resistance, heat and chemical resistance.

The specific architecture of the Nano-face masks with the microporosity of the layers and the nanoporosity in line with the controlled nanometer thickness of the nanolayers allow for reduced airflow resistance which enhances filtration efficiency and user's breathability.

By the described technology, the fine-tuning of the structural properties of the filter layers, and especially of the intermediate nanofilter and its components leads to the improvement of its efficiency and performance for a wide spectrum of personal protective equipment, medical, and non-medical face masks, respirators, face shields, eye glasses, protective clothes, biomedical devices, skin patches, and medical equipment and other.

To summarize, the advantages of the embodiment are: i) a high efficiency of filtration due to the fine-tuned nanoporosity, thickness and structural properties of the nanofilter that can entrap a diversity of nanometer sized particles, viruses, air pollutants, allergens, ii) usage of different filter layers with micropores and different shapes for protective filtering of microparticles, dust, aerosols, iii) further biofunctionalization with nanoparticles with anti-viral, anti-bacterial protection, iv) in case of nano-facemasks, the architecture of the nanofilter system, the nanoscale dimensions of the nanofilter layers and the high surface area due to nanoporosity, lower the resistance, or pressure differential in the mask interior, and v) high added value nanotechnology-enabled protective equipment. vi) diversity of nanoparticles can be embedded into the nanofilter with anti-viral, anti-bacterial protection,

The present invention also provides a robust, reliable method for fabricating the nanofilters and nanofilter systems and with excellent barrier and filtration capabilities by fine-tuning their structural, physicochemical properties.

This invention further relates to the functionalization of the nanofilters to enhance their anti-bacterial, anti-viral properties.

This invention lies on the design and production of tailored nanofilters with high efficiency filtration for personal protective equipment to overcome the objections in the prior art. These nanofilters may be applied but not limited to face masks, respirators, face shields, protective glasses and clothes, to protect healthcare workers and other individuals against microparticles, dust, bacteria, fumes, vapours, gases, allergens, air pollutants, airborne microorganisms and especially nanosized viruses, e.g. influenza, HIV, SARs, SARs-CoV-2.

The nanofilters may be also applied but not limited to the delivery of nanoparticles, organic or inorganic ones with antibacterial, antiviral properties, drugs, therapeutic agents, nanomedicines, or/and compounds, sensors.

In the following, a brief description of a way of carrying out the invention, with the use of examples, explaining the application of the invention is presented, which is illustrated by appended drawings related to the invention.

### BRIEF DESCRIPTION OF THE DRAWINGS

FIG. 1a shows a schematic representation of the structure of a Nanofilter System 100 for Nano facemasks composed of an external, coarse filter layer with microporosity 101, b Intermediate nanofilter with multi-functional, nanoporous filter layers involving single thin film (BP1:BP2 blend) 102, deposited onto the functional, thick, microporous filter, fiber-based layer 103, and c) an inner layer 104,

FIG. 1b depicts a schematic representation of the structure of the Nanofilter System 100 composed of a) an external, coarse filter layer with microporosity 101, b) an intermediate nanofilter, with a nanoparticulate layer, on top or embedded in a multi-functional, nanoporous filter layer involving single thin film (BP1:BP2 blend) 102, deposited onto the functional, thick, microporous, fiber-based filter layer 103, and c) an inner layer 104.

FIG. 1c shows a schematic representation of the structure of the Nanofilter System 100 composed of: a) an external, coarse filter layer with microporosity 101, b) Intermediate Nanofilter 102, made of multi-functional, nanoporous filter layers (involving bi-layer to multi-layer nanoporous BP thin films BP1, BP2, etc. deposited onto the functional, thick, microporous, fiber-based filter layer 103, and c) an inner layer 104.

FIG. 1d shows a schematic representation of the structure of the nanofilter system 100 composed of a) an external filter, microporous layer 101, b) an intermediate nanofilter 102 with a nanoparticulate layer, on top or embedded in multi-functional, nanoporous filter layers involving bi-layer or multi-layer BP thin films BP1, BP2, etc, deposited onto the functional, thick, microporous, fiber-based filter layer 103, c) an inner layer 104.

FIG. 2a depicts a schematic representation of the nanoporous BP blend in a single nanolayer structure by having a specific polymer blend ratio BP1:BP2, leading to controlled nanoporosity, nanopores size, and surface distribution.

FIG. 2b shows the schematic representation of the nanoporous BP multi-layer by characterizing a specific deposition order of the BP1, BP2, etc.

FIG. 3a shows AFM topography images of the nanofilter of the present invention produced by the slot-die technique (scan size 5 μm×5 μm).

In FIG. 3b the corresponding cross-section of FIG. 3a depicts the nanoporosity features.

FIG. 4 shows AFM topography images of the nanofilter of the filter system fabricated by gravure printing under variable experimental conditions including (A) a polymer concentration of 10 mg ml⁻¹, gravure printed with cell density of 150 line/inch, (scan size 5×5 μm); (B) a cross-section of a nanopore in FIG. 4a, (C) Polymer concentration of 10 mg ml⁻¹, gravure printed with cell density of 120 line/inch, (scan size 6×6 μm).

FIG. 5 depicts an AFM topography image of the silver Nanoparticles that can be applied for further functionalization of the body of the invention (scan size 2×2 μm).

FIG. 6 illustrates an embodiment of a sectional view of the Nano-facemask according to the invention with nanofilter position where the nanofilter System 100 apparatus will be placed and fixed 105 and its exhalation valve 106.

FIG. 7a illustrates a graphic illustration of the nanofilter system apparatus according to the invention with a protective molding seal 107 towards nano-facemask placement.

FIG. 7b depicts the adjustment of the nanofilter System apparatus 107 to the nano-facemask according to the invention and the external plastic cap 108 exhibiting holes that will be screwed tightly to the nanofilter apparatus to guarantee the non-removal of the nanofilter system during movements of the mask wearer.

FIG. 8a illustrates a paradigm of the protective nano-faceshield wherein the nanofilter is deposited to block nanometer sized and micrometer sized hazards.

FIG. 8b shows the functional layer of nanoparticles that is deposited onto the substrate of the nano-faceshield to advance its properties.

### DESCRIPTION

The invention relates to a method for design and development of nanofilters with high efficiency filtration for personal and protective equipment against microparticles, dust, bacteria, fumes, vapors, gases, allergens, air pollutants, airborne microorganisms and nanosized viruses, e.g. influenza, HIV, SARs, SARs-CoV-2, that are composed mainly of nanoporous, multi- or single layers of biodegradable polymeric (BP) thin films, which are featured by nanopores with tailored properties for the case of the following embodiments:

A first embodiment consists of a design of an advanced nanofilter system for Nano-face masks comprising an external, coarse filter thick layer with microporosity 101 for filtration of microparticles; further an intermediate nanofilter onto a functional, thick, microporous, fiber-based filter layer, wherein the nanofilter consists of multi-functional, nanoporous nanolayers involving single or more discrete layers, with or without nanoparticulate layer; and still further an inner filter of thick layer with microporosity and comfortable use. However, appropriate inner, outer, and filtration materials may be of a single or multiple layer design.

The materials used for the external and inner filter layers may be non-woven fibers like polypropylene (PP), cellulose, polystyrene, polycarbonate, polyethylene, and combinations thereof or polyesters, other hydrophobic polymers, hydrophobic fluoropolymers, or polymers is with hydrophobic surfactants, fluorosurfactants, without being limited thereto. The micropores block microparticles, dust, bacteria, fumes, vapors, gases, allergens, fungi, molds, air pollutants, airborne microorganisms. The nanopores provide a filter at the nanoscale against hazards like harmful nanoparticles, chemicals, viruses, gases and others.

A further embodiment consists of a design and synthesis of the intermediate nanofilter onto a functional, thick, microporous, fiber-based filter layer that serves as substrate for thin films deposition. The nanofilter consists of multi-functional, nanoporous layers involving: i) single layer BP blends or bi-layer/multilayer BP thin films characterized by tailored nanoporosity and nanoscale thickness, which can entrap airborne nanoparticles, nanometer sized substances, viruses, toxins, chemicals, gases, allergens, air pollutants, bacteria, and ii) a functionalization layer made of nanoparticles, or other agents, therapeutic compounds with nanoscale thickness. The nanofilter may be biofunctionalized or not with the nanoparticulate layer depending on the application.

The nanoporous layers of the filter may be constituted of a diversity of biodegradable polymers including different types of Poly (DL-lactide-co-glycolide) (PLGA) in terms of lactide: glycolide ratio, polycaprolactone (PCL), Polylactic acid (PLA), polysaccharides, polyesters, natural polymers with variations in degradation rates. In addition, other BPs can also be used, such as BP aliphatic polyesters, e.g. homopolymers and copolymers of lactic acid, glycolic acid, trimethylene carbonate, and blends, without being limited thereto. The nanolayers are deposited onto a functional, thick, microporous, fiber-based filter layer that is preferably fiber-based and made of non-woven fabrics, PA and other to enhance the filtration capacity of the nanofilter system.

A yet other example consists of tailoring the surface and structural properties, the nanoporosity, thickness of the BP thin films of the intermediate nanofilter for high filtration capability, by alteration in deposition parameters in line with the derived AFM and SE data for thin films characterization and quality control.

A still further example consists of a design and fabrication of an advanced anti-bacterial and anti-viral nanofilter system, by the delivery of silver nanoparticles in the filter layers and mostly either on top or embedded in the intermediate nanofilter. A diversity of NPs can be loaded ranging from inorganic ones besides silver, like titanium nitride, gold, zinc oxide, copper, without being limited thereto, and organic, polymeric NPs with anti-bacterial, anti-virus and other therapeutic agents, silver/metal compounds, quaternary ammonium compounds, N-halamines and anti-septic agents. Moreover, metal and polymeric NPs, sensors, theranostics, substances can be applied to enhance the functionality of the nanofilter system in regard to each specific application.

Another example consists of the development of the highly nanoporous nanofilter that consists of BP blends/or multi BP layers on inorganic and organic substrates like microporous PA and of the nanoparticulate nanofilters by slot die coating and gravure printing, though not limited, by other coating and printing techniques, such as electro-spraying, dipping, ink-jet printing, electrospinning, spin coating and vacuum deposition techniques. The nanofilter can be applied for all kinds of surface, and to all polymeric substrates such as PET, polycarbonate, cellulose acetate, PA, natural polymers, plastics, non-woven fabrics, etc. and other flexible substrates as well as inorganic ones like stainless steel, silicon, titanium and other metals, glass and other.

A yet further example consists of a design and development of nano-facemasks, respirators, based on the nanofilter system with exhalation valve, wherein the valve enhances the wearer's ease of breathing. The specific architecture of the mask nanofilter system with the microporosity of the filter layers and the nanoporosity combined with the nanometer thickness of the middle nanofilter allows for reduced airflow resistance and pressure differential (internal to ambient air) and therefore declined deflection of inhaled or exhaled air and airborne particles, which enhances filtration efficiency and wearer's comfort.

A yet other example consists of the design and fabrication of a nano-face shield that is composed of a 3D printed headband with strap and its main, functional and advanced part involving the nanofilter either alone or further functionalized with NPs with controlled transparency, antiviral and anti-bacterial properties after proper surface treatment.

This method can be generally applied, notably in the case of monolayer and multilayer thin films of organic polymeric, biodegradable or not, nanomaterials that can be used for the production of nanofilters and nanofilter systems for personal, medical protection equipment and may have application in healthcare, industrial, public, domestic, or other settings. Hence, these nanotechnology-enabled products can be used for healthcare workers, any workers subject to harsh environmental conditions or individuals during a pandemic like COVID-19.

The nanofilters and nanofilter systems may be applied but not limited to face masks, respirators, face shields, protective glasses, gloves and clothes, air and gases filtration, food processing applications, food packaging, kidney filtration membranes, skin patches, pharmaceuticals, fine chemicals, flavor, fragrance, cosmetics, implants and biomedical devices.

Measurements were realized based on a series of experiments performed for the presentation and the use of the proposed technique which are set out below.

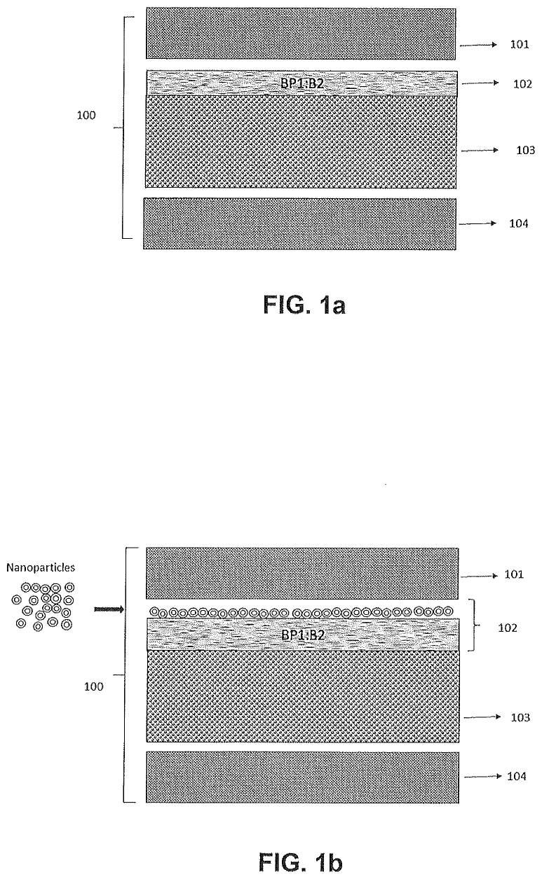

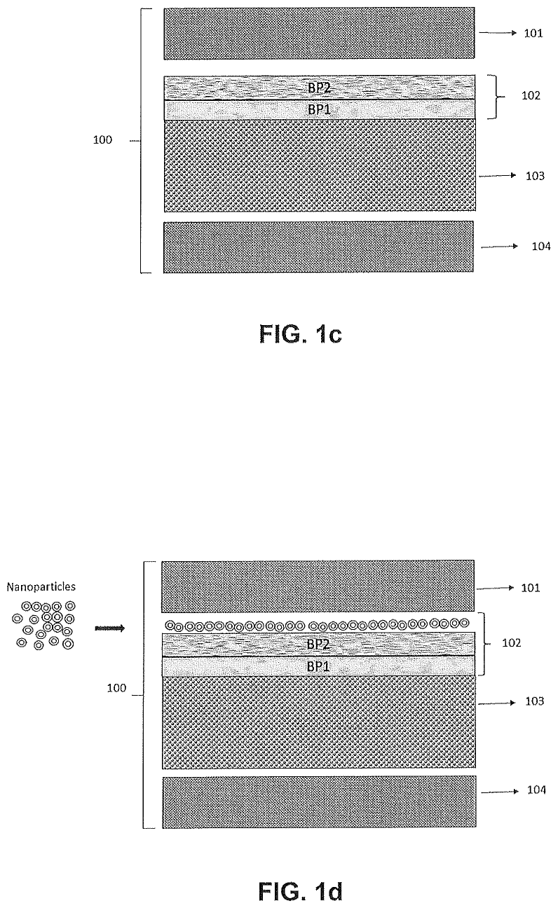

FIG. 1 depicts the architecture of the nanofilter system for Nano-face masks and its components.

Specifically, FIG. 1a shows a schematic representation of the structure of the nanofilter system 100 for nano-facemasks composed of a) an external, coarse filter layer with microporosity 101, b) an intermediate nanofilter with multi-functional, nanoporous filter layers involving single thin film (BP1:BP2 blend) 102, deposited onto the functional, thick, microporous filter, fiber-based layer 103, and c) an inner layer 104.

FIG. 1b depicts a schematic representation of the structure of the nanofilter system 100 composed of: a) an external, coarse filter layer with microporosity 101, b) an intermediate nanofilter, with a nanoparticulate layer, on top or embedded in a multi-functional, nanoporous filter layer involving single thin film (BP1:BP2 blend) 102, deposited onto the functional, thick, microporous, fiber-based filter layer 103, c) an inner layer 104.

FIG. 1c presents a schematic representation of the structure of the nanofilter system 100 composed of: a) an external, coarse filter layer with microporosity 101, b) an intermediate nanofilter 102, made of multi-functional, nanoporous filter layers involving bi-layer to multi-layer nanoporous BP thin films BP1, BP2, etc. deposited onto the functional, thick, microporous, fiber-based filter layer 103, and c) an inner layer 104.

FIG. 1d presents a schematic representation of the structure of the Nanofilter system 100 composed of: a) External filter, microporous layer 101, b) Intermediate Nanofilter 102 with a nanoparticulate layer, on top or embedded in multi-functional, nanoporous filter layers (involving bi-layer or multi-layer BP thin films BP1, BP2, etc.), deposited onto the functional, thick, microporous, fiber-based filter layer 103, c) Inner layer 104.

The design of the nanofilter system is based on the requirements of each application. Different type of materials may comprise the layers to enhance the filtration capacity. The multi-functional, intermediate nanofilter with controllable nanoporosity and thickness can provide protection against different particles, nanometer sized viruses, nanoscale hazards, bacteria, and others.

In the case of the Nano-facemasks, the external layer should be microporous and hydrophobic and may be composed of, but not limited to, non-woven fabrics, PP, polystyrene, polycarbonate, polyethylene, and combinations thereof or polyesters, other hydrophobic polymers, hydrophobic fluoropolymers, or polymers with hydrophobic surfactants, fluoro-surfactants, etc. The micropores can block microparticles, dust, bacteria, fumes, vapors, gases, allergens, air pollutants, airborne microorganisms. For the production of the intermediate, multi-functional nanofilters, different classes of biodegradable polymers, e.g. BP1, BP2, etc., in terms of molecular weight, monomers ratio, crystallinity, hydrophobicity, surface free energy and surface charge can be deposited in a multi-layer structure or in a single layer—blend of BP polymers—onto the microporous, thick filter substrate [18],

The intermediate nanoporous layers of the nanofilter can be biofunctionalized with diversity of anti-bacterial, anti-viral, therapeutic agents, inorganic or organic nanoparticles, nanomedicines, chemical and natural compounds to enhance its effectiveness not only by blocking and trapping the nanosized viruses—such as influenza, SARs-CoV-2, and others—within the nanopores, but also inactivate them. The NPs can be deposited by different wetting and printing techniques either onto the surface or embedded in the nanoporous layers of the nanofilter—or onto the other filter layers of the system—to meet the requirements for each need. However, it will be understood by those of ordinary skill in the art that sensors, diagnostic and theranostic NPs, substances can be loaded as well.

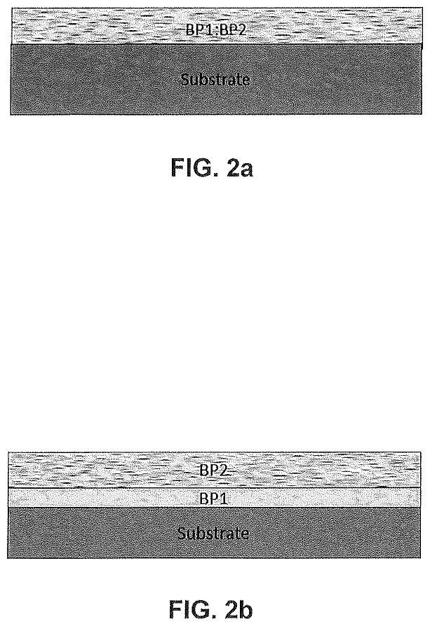

FIG. 2a depicts a schematic representation of the nanoporous BP blend in a single nanolayer structure by having a specific polymer blend ratio BP1:BP2, leading to controlled nanoporosity, nanopores size, dimensions and surface distribution.

FIG. 2b presents the schematic representation of the nanoporous BP two to multilayer by characterizing of a specific deposition order of the BP1, BP2, etc. [18]. The appropriate blend of the biodegradable polymers can be applied by, slot-die coating, gravure printing, but not limited to spraying, dipping, ink-jet printing, spin coating, electro-spraying, and other, onto polyamides, inorganic or organic substrates.

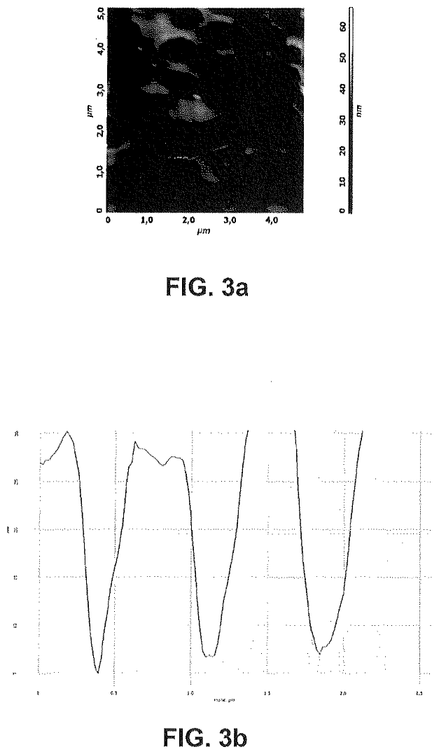

FIG. 3a shows AFM topography images of the nanoporous layer of the nanofilter onto the PA microporous filter layer of the present invention produced by the slot-die technique (scan size 5 μm×5 μm). The dimensions, density of the nanopores in line with the thickness of the layer are essential factors that determine the filter functionality. The nanoporosity and thickness can be tailored under different deposition parameters like pump rate in line with polymer concentration, polymer ratio as measured by SE, AFM. Slot-die coating is an extremely versatile deposition technique that possesses the advantages of the simple relationship between wet-film coating thickness, the flow rate of solution, and the speed of the coated substrate relative to the head; the ability of producing uniform films across large areas and its ease of integration into scale-up processes including roll-to-roll coating and sheet-to-sheet deposition systems. The technique itself offers high levels of coating uniformity across the length/width of the coating surface and can deposit thin-films with thicknesses ranging from a few nanometers to many microns. It can do this for a wide range of solution types and viscosities at rates ranging from a few centimeters per second to several meters per second.

In FIG. 3b, the corresponding cross-section of FIG. 3a depicts the nanoporosity features. Characterization of the single nanopores revealed a variation in diameter ranging from 100 to 350 nm, of the double nanopores the diameter is measured to be approximately 700 nm i.e. 350 nm for each nanopore. The AFM measurements showed that the polymer concentration, the polymer blend ratio and the pump rate affect mainly the nanoporosity and thickness of the nanoporous layers. Especially, by controlling the pump rate during the slot-die process, the thicknesses of the nanoporous thin films as measured by SE can be achieved to allow higher filtration efficacy without increasing the air resistance within the filter.

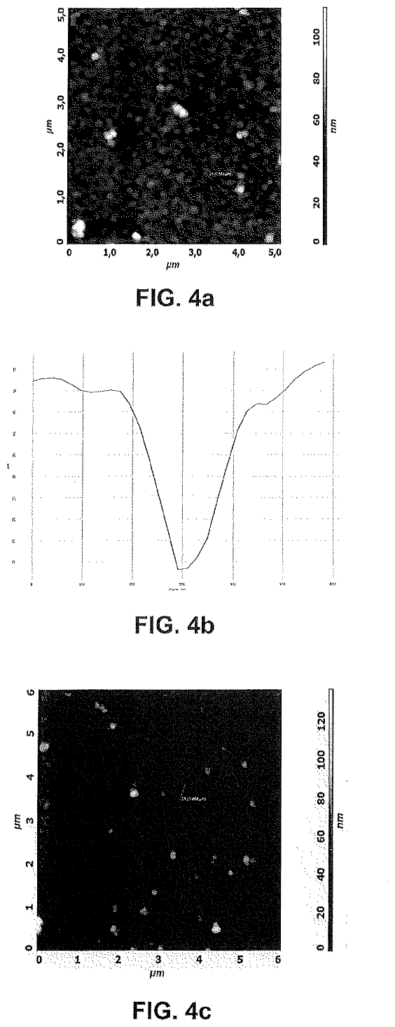

FIG. 4 shows AFM topography images of the nanoporous layer of the Nanofilter onto PA substrate fabricated by gravure printing under variable experimental conditions set as follows:
(A) polymer concentration of 10 mg gravure printed with cell density of 150 line/inch with scan size 5×5 μm,
(B) Cross-section of a nanopore in FIG. 4a,
(C) Polymer concentration of 10 mg ml⁻¹, gravure printed with cell density of 120 line/inch with scan size 6×6 μm.

The polymeric mixture was printed by the gravure printing technique using a printing pattern with cell density of 150 line/inch, or 120 line/inch and cell depth of 40 μm.

The AFM images demonstrated that by varying the polymer blend ratio, the polymer concentration, the gravure printing parameter (lines per inch), multi-sized nanopores with controlled dimensions and density as well as desirable layer thickness (SE derived data) can be produced to allow breathability with maximum filter efficacy.

Due to the outbreak of the emerging infectious diseases caused by different pathogenic viruses like the COVID19 pandemic, NPs have emerged as novel antimicrobial and anti-viral agents thanks to the observation of their high surface area to volume ratio and their unique chemical and physical properties.

In some embodiments, the agent that can be loaded into the nanofilter for biofunctionalization includes the following one or more substances without being limited thereto: anti-bacterial, anti-viral agents, silver, titanium, titanium nitride, zinc, copper, gold, metal oxide nanoparticles such as iron oxide, zinc oxide, and titanium dioxide NPs and other, nanomedicines, chemical and natural compounds, peptides, resin-based composites, drugs, chlorhexidine, sensors, diagnostic NPs, etc,

Thus, the anti-bacterial and anti-viral activities of the nanofilter system can be enhanced by the deposition of metal nanoparticles onto the filter layers, especially onto the intermediate nanofilter.

The selection of the NPs in terms of material type, size and physicochemical properties is based on the viral or bacterium invader characteristics that need to be blocked and inactivated, involving its size, structure, surface charge, membrane receptors and binding proteins. For example, the SARS-CoV-2 virus with the size of 60-140 nm and spherical shape entries the host cells by a transmembrane spike (S) glycoprotein comprises two functional subunits responsible for binding to the host cell receptor (S1 subunit) and fusion of the viral and cellular membranes (S2 subunit).

Silver nanoparticles are the most effective of the metallic NPs against bacteria, viruses and other eukaryotic microorganisms, particularly due to the inherent inhibitory and bactericidal potential of silver, but also because of their good conductivity, catalytic properties, and chemical stability. The key mechanisms of action of silver NPs are the release of silver ions which enhances antimicrobial activity-, cell membrane disruption, and DNA damage [19].

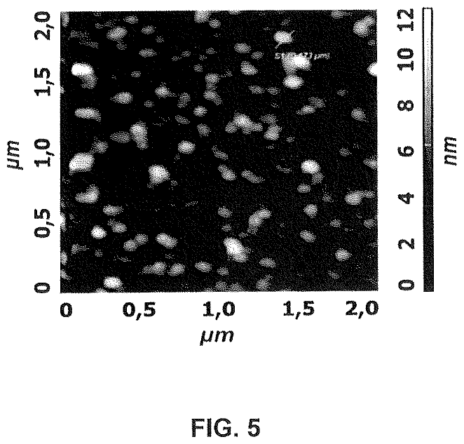

Taking all these into account, a paradigm of functionalized silver NPs with the sizes of 10 nm is depicted in FIG. 5, wherein AFM topography images of the silver NPs that can be applied for further functionalization of the body of the invention are presented (scan size 2×2 μm).

The silver NPs can be functionalized for capture of specific gaseous airborne threats by different agents, surfactants, like Polyvinyl alcohol (PVA), and Polyethylene glycol (PEG), polyvinylpyrrolidone (PVP), cationic surfactants, anionic sodium dodecylbenzenesulfonate (LAS), cationic dodecyltrimethylammoniumchloride (DTAC) and non-ionic Berol 266 (Berol), etc. to enhance stability, to minimize toxicity and to reduce NPs agglomeration.

In some embodiments, the anti-bacterial, anti-viral nanoparticles can be deposited onto nano-facemasks, respirators, face shields, protective clothes, glasses, and shoes, personal and medical protective equipment and may have application in health care, industrial, public, domestic, or other.

The nanoparticles can be loaded into the nanofilters, facemasks, face shields and other protective equipment by slot die coating, gravure printing and by other coating and printing techniques, such as electrospraying, electrospinning, dipping, ink-jet printing, spin-coating, spraying and vacuum deposition techniques, without being limited thereto.

In some embodiments, functional organic and metal nanoparticles, sensors, substances can be applied to enhance the properties of the nanofilters and systems in regard to each specific application.

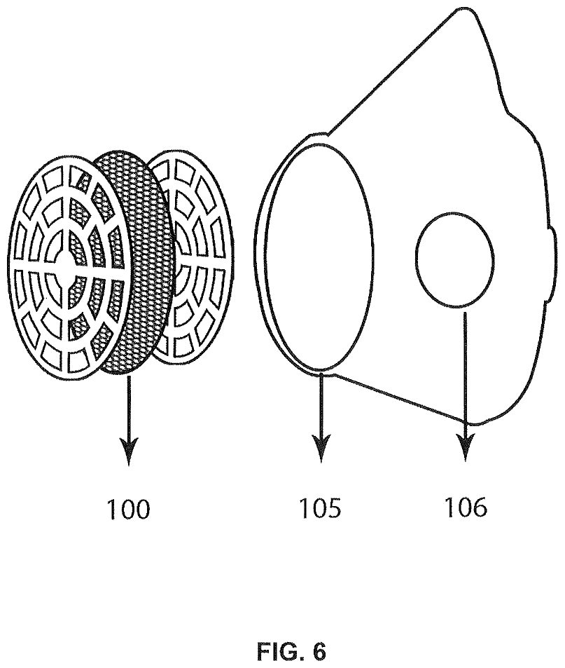

FIG. 6 illustrates an embodiment of a sectional view of the nano-facemask with nanofilter position where the nanofilter system 100 apparatus gets placed and fixed 105 and its exhalation valve 106. The current medical masks, like N95 respirators, incorporate filter materials wherein the fiber diameter and density are the main parameters that maintain the balance between filtration efficacy and pressure gradient between inside and outside the mask. The prior art teaches that the higher fibers density and diameter provide more air resistance to the wearer and difficulty in breathing. The pressurized gas will seek equivalence to ambient (lower) air pressures through the pathway of less resistance, namely any leak around the mask, rather than through the dense filtration material. This creates a condition whereby airflows are deflected off of the mask material (inner, and filter layers) rather than passing through it.

The main advantage of this embodiment lies on the fact that the nanofilter system as a crucial component of the nano-facemask with the controllable thickness—ranging from a few nanometers up to a few micrometers—and nanoporosity—dimensions of nanopores, density—of the nanofilter will lead to lower pressure gradients—internal to ambient air—and less leakage around the mask. The specific architecture of the nano-facemasks with the microporosity of the external, intermediate functional and internal layer and the advantageous nanoporous layer of the nanofilter allows for a reduced airflow resistance and therefore declined deflection of inhaled or exhaled air and airborne particles, which enhances filtration efficiency and wearer's comfort. The diversity of pores of the filter layers—in terms of size micrometers up to nanometers, and of morphology—may block the passage of airborne micro to nanoparticles including viruses, bacteria, dust, spores, and mold and chemical pollutants.

Another advantage of the embodiment is the fact that both the nano-facemasks and nanofilter systems are re-useable with enhanced durability after proper sterilization.

In some embodiments, the nanoporous layers of the nanofilter—either single or multi-layer structure—can be in a discrete layer(s) between the outer and inner layer. In some embodiments, the nanofilter can make up the middle layer or can be disposed on the middle layer of the facemask.

In some embodiments, the nanoporous thin films can be disposed on the inner, middle and/or outer layer by slot-die, gravure printing, spraying, dipping, ink-jet printing, electro-spraying and other coating and printing techniques.

In some embodiments, the nanofilter system can be adapted to all type masks, standard surgical and N95 masks, shapes, sizes, made of different materials to meet the demand for different technical requirements.

Especially in the case of surgical or medical face masks, the nanofilters can replace the middle layer, the melt-blown filter layer, or can be deposited onto the melt-blown one by the methods of the invention.

The mask can be made of a diversity of filtration materials including but not limited to woven and non-woven fabrics, plastics, polypropylene melt-blown fibers, polymers, hydrophobic materials, cellulose, thermoplastics, thermosets, elastomers, polymers with incorporated fillers, biopolymers, and polymers blended with biological materials and can be produced by versatile techniques involving Additive manufacturing (AM) like 3D printing, ink jet printing, roll-2-roll printing, thermoplastic processes, extrusion and injection molding, melt blown processes and other in accordance with the specific application.

In this embodiment, the Nano-face mask can be produced by 3D-printing and comprises of the nanofilter system position, exhalation valve, elastic bands around head and a soft, flexible material, soft rubber or elastomer seal against face like thermoplastic polyurethane, or TPU, to guarantee the tight fit with the face of the wearer.

The exhalation valve is to ensure a regular air flow, heat and moisture reduction inside the filtering face mask as it allows hot and humid air outflow. The mask can cover the nose, the mouth and cheeks of the user. Hence, it will be understood by those of ordinary skill in the art that other shapes of the face mask can be made in order to cover both the eyes, hair, and throat of the wearer, with or without exhalation valve.

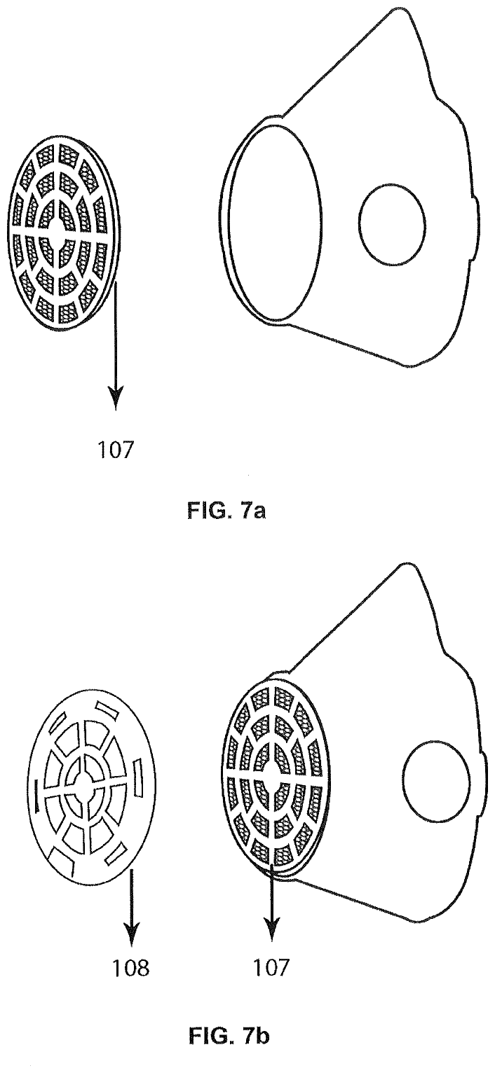

FIG. 7a illustrates a graphic illustration of the nanofilter system apparatus with a protective molding seal 107 towards nano-facemask placement.

However, it will be understood by those of ordinary skill in the art, that the materials, shapes, structures, fabrication processes of the protective filter seals can be adapted to different technical requirements, material substrates, designs and processes for facemasks, nanofilter systems, filters, and other products.

FIG. 7b depicts the adjustment of the nanofilter system apparatus 107 to the nano-facemask and the external plastic cap 108 exhibiting holes that will be screwed tightly to the nanofilter system apparatus.

In some embodiments, the external plastic cap is screwed tightly to the nanofilter system apparatus to avoid filter removal during the movement of the user.

In some embodiments, different shapes, designs, structures, materials and production techniques can be applied for the external protective cap of the nanofilter system.

In some embodiments, the nano-facemask can be either be comprised of a more rigid part involving polymeric filaments of PLA and of a flexible part made of TPU, shape memory filaments, or combination of both. The thermoplastic can provide a secure fit of the mask onto the face which prevents gaps and passage of material between the nostrils and mouth and the surrounding environment. Besides 3D printing, the thermoplastics can be produced and reshaped though not limited by injection molding, compression molding, calendaring, melt blown processes and extrusion.

The architectural design and choice of polymers can lead to materials with enhanced functionalities, mechanical properties, porosity, and stability. However, it will be understood by those of ordinary skill in the art that the design of the mask can be adapted to different material substrates, conditions and processes for large scale production.

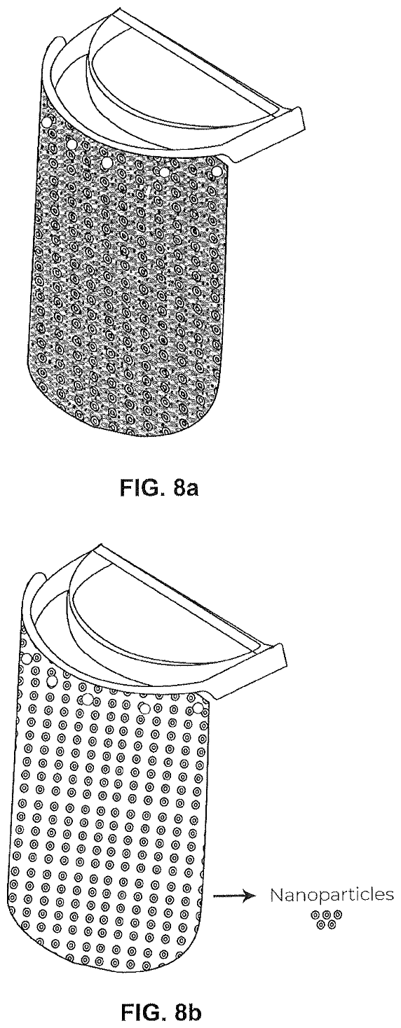

FIG. 8a illustrates a paradigm of the protective nano-faceshield wherein the nanofilter is deposited to block nanometer sized and micrometer sized hazards. FIG. 8b shows the functional layer of nanoparticles that is deposited onto the plastic substrate of the Nano-face shield to advance its properties.

Besides NPs, other agents, substances are deposited onto the substrate e.g. PET, polycarbonate, cellulose acetate, plastics to advance the protection of the user. Metal or organic NPs with anti-bacterial, anti-viral activities can be loaded to provide anti-viral and anti-bacterial protection for healthcare workers, workers in industrial, public, domestic environment. In some embodiments, functional organic and metal nanoparticles, sensors, substances, nanomedicines, chemical and natural compounds, peptides can be applied to enhance the barrier and filter properties of the nanofilter in regard to each application.

The surface chemistry, wettability, optical or other material properties, including, but not limited to different material composition are taking into account for the appropriate surface treatment of the shield substrate for the successful deposition of the nanofilter with or without NPs or NPs alone. The nanofilter can provide a high filtration efficiency to advance the nano-shield protective function against microorganisms, dust, chemicals, air pollutants, mold, viruses and other.

The applications of the device body of the present invention includes but not limited to the following ones: personal, medical protection equipment, face masks, respirators, face shields, protective glasses, gloves and clothes, air and gases filtration, food processing applications, agriculture, food packaging, kidney filtration membranes, skin patches, pharmaceuticals, fine chemicals, flavor, fragrance, cosmetics, implants, biomedical devices, medical equipment. The nanofilters and nanotechnology-enabled products may have application in healthcare, industrial, public, domestic, or other settings as they can be used by healthcare workers, any workers subject to harsh environmental conditions, or individuals during a pandemic like COVID-19.

In some embodiments, the nanofilter system can be adapted to all type masks, standard surgical and N95 masks, shapes, sizes, made of different materials to meet the demand for different technical requirements. Especially in the case of surgical or medical face masks, the nanofilters can replace the middle layer, the melt-blown filter layer, or can be deposited onto the melt-blown one by the methods of the invention.

To summarize, the present invention relates to nanofilters and nanofilter systems for personal and health care protective equipment to protect against health and safety hazards having application in healthcare, industrial, public, domestic environments. it also relates to a robust, reliable method for fabricating thereof with higher filtration efficiency, and to Nano-face masks, respirators, Nano-face shields exhibiting antibacterial, anti-viral protection and particulate-filtering due to the excellent barrier and filtration properties of the nanofilter system.

This invention lies on the design and production of tailored Nanofilters and nanofilter systems with high efficiency filtration for personal protective equipment to overcome the objections in the prior art. These Nanofilters and nanofilter systems are applied to face masks, respirators, face shields, protective glasses and clothes, to protect healthcare workers and other individuals against microparticles, dust, bacteria, fumes, vapors, gases, allergens, air pollutants, airborne microorganisms and especially nanosized viruses such as influenza, HIV, SARs, SARs-CoV-2.

The Nanofilters and systems may be also applied to the delivery of nanoparticles, organic or inorganic ones with antibacterial, antiviral properties, drugs, therapeutic agents, nanomedicines, or/and compounds, sensors.

### REFERENCES

1. Https://www.fda.gov/. Personal Protective Equipment for Infection Control. (2020).
2. Larry Janssen, Harry Ettinger, Stephan Graham, Ronald Shaffer, and Z. Z. The Use of Respirators to Reduce Inhalation of Airborne Biological Agents. J OccupEnv. Hyg. 10,97-103 (20′13).
3. Bunyan, D., Ritchie, L., Jenkins, D. & Coia, J. E. Respiratory and facial protection: A critical review of recent literature. J. Hosp. Infect. 85,165-169 (2013).
4. Wang, Q. et al. Structural and functional basis of SARS-CoV-2 entry by using human ACE2. Cell 1-11 (2020). doi:10.1016/j.cell.2020.03.045
5. Cascella M, Rajnik M, Cuomo A, et al. Features, Evaluation and Treatment Coronavirus (COVID-19). (StatPearls Publishing, 2020).
6. Stanley, W. M. The size of influenza virus. J. Exp. Med. 79,267-283 (1944).
7. Poutanen, S. M. Human Coronaviruses. Principles and Practice of Pediatric Infectious Diseases: Fourth Edition1, (Elsevier Inc., 2012).
8. Lee, S. A. et al. Particle size-selective assessment of protection of European standard FFP respirators and surgical masks against particles-tested with human subjects. J. Health. Eng. 2016,1-12 (2016).
9. Leung, N. H. L. et al. Respiratory virus shedding in exhaled breath and efficacy of face masks. Nat. Med. (2020).
10. Rengasamy S1, Shaffer R1, Williams B2, Smit S2. A comparison of facemask and respirator filtration test methods. J Occup Environ Hyg. 2017 Feb; 14(2):92-103.
11. Https://www.cdc.gov/ Lisa Brosseau, R. B. A. N95 Respirators and Surgical Masks. (2009).
12. M. Loeb, N. Dafoe, J. Mahony et al., “SurgicalmaskvsN95 respirator for preventing influenza among health care workers: a randomized trial,” The Journal of the American Medical Association, vol. 302,no. 17,pp. 1865-1871,2009.
13. Offeddu, V., Yung, C. F., Low, M. S. F. & Tam, C. C. Effectiveness of Masks and Respirators against Respiratory Infections in Healthcare Workers: A Systematic Review and Meta-Analysis. Clin. Infect. Dis. 65,1934-1942 (2017).
14. Loeb M, Dafoe N, Mahony J, et al. Surgical mask vs N95 respirator for preventing influenza among health care workers: a randomized trial. JAMA302,1865-1871 (2009).
15. MacIntyre C R, Wang Q, Cauchemez S, et al. A cluster randomized clinical trial comparing fit-tested and non-fit-tested N95 respirators to medical masks to prevent respiratory virus infection in health care workers. Influ. Other Respir Viruses 170-179 (2011).
16. MacIntyre, C. R. et al. A randomized clinical trial of three options for N95 respirators and medical masks in health workers. Am. J. Respir. Crit. Care Med. 187, 960-966 (2013).
17. V. Karagkiozaki, S. Logothetidis. Horizons in Clinical Nanomedicine Book, Pan Stanford Publications (2014)
18. V. Karagkiozaki, S. Logothetidis. Method for production of nanoporous multi-layer biodegradable polymeric coatings and products thereof, EP2703016A1 patent, US20140072608A1 patent.
19. Singh, Lavanya et al. “The role of nanotechnology in the treatment of viral infections.” Therapeutic advances in infectious disease vol. 4,4 (2017): 105-131.

1. Nano-filter system for personal and medical protective equipment against health and safety hazards, characterised in that it comprises:
an external, coarse filter thick layer with microporosity for filtration of microparticles,
an intermediate nanofilter forming middle filter nanolayer, onto a functional, thick, microporous, fiber-based filter layer, wherein the nanofilter consists of multi-functional, nanoporous nanolayers involving single or more discrete layers, possibly with a nanoparticulate layer, either a single or a plurality of discrete nanoporous layers,
an inner filter of thick layer with microporosity,
wherein the inner, outer, and filtration materials are of a single or multiple layer design.

2. Filter system according to claim 1, characterised in that said external and inner filter layers are made of non-woven fibers, which are selected among polypropylene (PP), cellulose, polystyrene, polycarbonate, polyethylene and combinations thereof or polyesters, other hydrophobic polymers, hydrophobic fluoropolymers, or polymers with hydrophobic surfactants, fluoro-surfactants, wherein the micropores block microparticles, dust, bacteria, fumes, vapors, gases, allergens, fungi, molds, air pollutants, airborne microorganisms.

3. Filter system according to claim 1, characterised in that said intermediate nanofilter is composed of:
a nanoporous nanolayer consisting of single layer biodegradable polymeric (BP) blends or of multi-layer BP thin films, preferably with multi-sized nanopores and nanometer thickness, characterized by tailored nanopores, a controllable thickness of the layers so as to entrap nanoscale viruses and to allow fluent breathing,
a layer of nanoparticles as functional agents, for nanolayer biofunctionalization, wherein the nanofilter is possibly biofunctionalized with the nanoparticulate layer and it is deposited onto a functional, thick, microporous filter layer which is preferably fiber-based and made of non-woven fabrics, notably Polyamide (PA);
wherein said middle filter nanolayer, single layer biodegradable polymeric (BP) blends or two multilayer BP thin films are characterized by tailored nanoporosity and nanoscale to pm thickness, to entrap airborne nanoparticles, nanometer sized substances, viruses, toxins, chemicals, gases, allergens, air pollutants, bacteria;
and In that the nanoporous layers of the filter are constituted by biodegradable polymers BP consisting of different types of Poly (DL-lactlde-co-glycolide) (PLGA) in terms of lactlde:glycolide ratio, polycaprolactone (PCL), Polylactic acid (PLA), polysaccharides, polyesters, natural polymers with variations in degradation rates, particularly wherein other BPs, BP aliphatic polyesters notably homopolymers and copolymers of lactic acid, glycolic acid, trimethylene carbonate, and blends, are included.

4. Method for manufacturing a filter system as defined in claim 1, characterised in that the surface and structural properties, the nanoporosity, thickness of the said BP thin films of the filter nanolayer for high filtration capability, is tailored by alteration in deposition parameters in line with the derived spectroscopic ellipsometry and Atomic Force Microscopy (AFM) data for thin films characterization and quality control,
particularly wherein the control of nanoporosity and thickness of the engineered nanomaterials is performed upon the fabrication method, by alterations in deposition parameters, polymer types, material and ratios, in line with ultrasensitive measurements and monitoring by Atomic Force Microscopy (AFM) and Spectroscopic Ellipsometry (SE), for a detailed characterization of the structural properties of the engineered systems for the achievement of their functionality.

5. Method according to claim 4, characterised in that, in terms of a biofunctionalization process of said intermediate layer, a diversity of nanoparticles (NPs) is loaded in the filter layers for enhancing the anti-bacterial and anti-viral activities of the filter system, and in that silver nanoparticles are delivered in said filter layers, mostly in the nanoporous layer, for obtaining an anti-bacterial and anti-viral nanofilter system; particularly wherein nanomedicines, theranostics, sensors and said loaded NPs are ranging from inorganic ones apart from silver, including titanium nitride, gold, metal oxide, zinc oxide, titanium dioxide, copper, on the one hand, and organic, polymeric NPs loaded with antibacterial, anti-virus and other therapeutic agents, natural, silver/metal compounds, quaternary ammonium compounds, N-halamines and anti-septic agents, on the other hand.

6. Method according to claim 4, characterised In that a highly nanoporous filter consisting of BP blends or BP multilayers onto inorganic and organic substrates and of the nanoparticulate filters, is manufactured by wetting and printing techniques among slot die coating, gravure printing and other coating and printing techniques respectively, including electro-spraying, ink-jet printing, electrospinning, dipping, spin coating, spray coating, and vacuum deposition techniques, which are selectively applied for the functionalization of said nanoporous BP layers onto said organic and inorganic substrates.

7. Method according to claim 4, characterised in that said nanofilter is applied for various surfaces to polymeric organic substrates selected among Poly(Ethylene Terephthalate) (PET), polycarbonate, cellulose acetate, natural polymers, plastics, non-woven fabrics and other flexible substrates, as well as inorganic substrates selected among stainless steel, silicon, titanium and other metals, glass;
particularly wherein the process is optimized in that working parameters are set among the monomers ratio, molecular weight, crystallinity, hydrophilicity and surface free energy of the BPs, the BPs deposition in a specific order, the polymerblend ratio, the polymerNPs ratio in the thin films, combined with their desirable concentration, therapeutic actions, wherein said method for fabricating the nanofilters has a high filtration efficiency,

8. The method according to claim 4, characterised in that said filter system is applied in the case of monolayer and multilayer thin films of organic polymeric, possibly biodegradable, nanomaterials, for the production of nanofilters for personal, medical protection equipment, with application in healthcare, industrial, public, domestic, particularly wherein these nanotechnology-enabled products are used for healthcare workers, any workers subject to harsh environmental conditions, or individuals during a pandemic notably of COVID-19,
wherein the nanoporous filters are applied mainly to face masks, respirators, face shields, protective glasses, gloves and clothes, but also to air and gases filtration, food processing applications, food packaging, kidney filtration membranes, skin patches, pharmaceuticals, fine chemicals, flavor, fragrance, cosmetics, implants, biomedical devices.

9. Face mask, incorporating the said nanofilter system as defined in claim 1, characterised in that said face mask comprises an exhalation valve enhancing the wearer's ease of breathing, and a nanofilter with the microporosity of the external and internal layer and the nanoporosity combined with the nm thickness of the middle nanolayer that generates a reduced airflow resistance and pressure differential—internal to ambient air—thus yielding a declined deflection of inhaled or exhaled air and airborne particles, thereby enhancing the filtration efficiency and mask wearer's comfort.

10. Face mask according to claim 9, characterised in that the external filter layer is disposed on the middle layer and in that it is made of non-woven fiber material that is microporous and breathable, notably selected among polypropylene (PP), polystyrene, polycarbonate, polyethylene, and combinations thereof or polyesters, other hydrophobic polymers, hydrophobic fluoropolymers, or polymers with hydrophobic surfactants, fluoro-surfactants,
wherein the tailored multi-functional multilayer serves as the middle layer disposed on the inner layer made of nonwoven fiber material suitable both to contact the wearer's face and for comfortable use, wherein the intermediate multi-functional layer is not permeable to viruses, allergens, bacteria, mold, nanosized particles, chemicals also allowing breathability through the whole surface area.

11. Face mask according to claim 9, characterised in that it further comprises an external plastic cap provided with holes serving as protective filter seal, which is fastened tightly to the nanofilter system apparatus to avoid filter removal during the movement of the user.

12. Face mask according to claim 9, characterised in that for surgical or medical face masks, the nanofilters replace the middle layer, the melt-blown filter layer, or in that it is deposited onto the melt-blown one.

13. Face mask according to claim 9, characterised in that it is 3D printed.

14. Face mask according to claim 9, wherein said mask is extended to a respirator, wherein said nano-face device exhibits antibacterial, anti-viral protection and particulate-filtering due to the high efficiency of said nanofilter system incorporated therein.

15. Face shield, incorporating said nanofilter as defined in claim 1, characterised in that is composed of a notably 3D printed headband with strap and a nanoparticulate nanofilter with transparency, antiviral and anti-bacterial properties that is deposited onto the plastic shield after an adapted surface treatment, wherein said face shield exhibits an antibacterial and anti-viral protection as well as a particulate-filtering due to the high efficiency of said incorporated nanofilter.
